(19) United States
(12) Patent Application Publication
(10) Pub. No.: US 2008/0231814 A1
(43) Pub. Date: Sep. 25, 2008

(54) Display device

(76) Inventors: Robert Boekamp, Paderborn (DE); Norbert Mertens, Hoexter (DE)

Correspondence Address: CLEMENTS BERNARD MILLER, 1901 ROXBOROUGH ROAD, SUITE 300, CHARLOTTE, NC, 28211, US

(21) Appl. No.: 11/818,806

(22) Filed: Jun. 15, 2007

(30) Foreign Application Priority Data
Mar. 21, 2007 (EP) 07 104 616.3

(51) Int. Cl. G03B 21/14

(52) U.S. Cl. 353/79

(57) ABSTRACT

A display device comprises a height-adjustable display board (10) which is adapted to be written on. Further, the display device comprises a height-adjustable projection unit (18) for projecting images onto the display board (10). With the aid of a mechanical connection means (20,22) connecting the display board (10) to the projection unit (18), it is guaranteed that, upon vertical displacement of the display board (10) or the projection unit (18), a vertical distance between the display board (10) and the projection unit (18) will be substantially maintained.

The present invention relates to a display device.

### BACKGROUND OF THE INVENTION

Display devices in the present context comprise a display board which is adjustable in height and can be written on. Such a board can be provided e.g. as an information display board or a blackboard of the type used in school, adapted to be written on by pencils or crayon. The display device further comprises a likewise height-adjustable projection unit. By means of the projection unit, which is particularly a beamer, images can be projected onto the display board. The images can be stationary images, films, projected monitor images and the like.

A display device of the above type is described in DE 20 2005 016 926. Such display devices generally suffer from the problem that, when the height of the display board is being adjusted, the images on the display board will be shifted and thus possibly be cut off or even vanish altogether. To avoid such disturbing effects, it has been proposed in DE 20 2005 016 926 to connect both the display board and the projection unit with a respective motor drive for height adjustment. The two motor drives for height adjustment are connected to a control unit wherein, by means of the control unit, it is safeguarded that the two adjustment paths will be identical. A display device of this type has the disadvantage of being sluggish. A further problem resides in that, when the electric motor is switched on, forces are suddenly transmitted to the projection unit, causing the projection unit to vibrate or shake.

It is an object of the present invention to provide a display device in which it is safeguarded in a simple manner that a displacement of the display board or the projection unit will result in a corresponding displacement of the projection unit and the display board, respectively.

According to the present invention, the above object is achieved by the features indicated in claim 1.

### SUMMARY OF THE INVENTION

The display device of the invention comprises a display board which is adapted to be written on and which is adjustable in height. The display device further comprises a height-adjustable projection unit for projecting images, particularly stationary or moving images, onto the display board. According to the invention, there is provided a mechanical connection means by which the display board is mechanically connected to the projection unit. As provided by the invention, the connection means is configured to the effect that, when the display board or the projection unit is shifted, a vertical distance between the projection unit and the display board will be substantially maintained. Thus, a displacement of the display board in a vertical direction by a certain distance will result in a corresponding displacement of the projection unit by the same distance in the vertical direction. Therefore, the display board and the projection unit will always be arranged at the same height relative to each other. According to the invention, this effect is obtained exclusively by the mechanical connection means proposed herein. Thus, expressed in simple terms, what is effected here is a parallel displacement movement of the display board and the projection unit into the same direction, accomplished with the aid of the connection means. Consequently, it is guaranteed that the projection angle between the projection unit and the display board is substantially maintained. Also the projection field, i.e. the region in which the projected image is visually represented on the display board, will remain unchanged.

The provision of the above described mechanical connection means obviates the need for a complex installation of electric adjustment motors and for corresponding control processes. This does not only offer the advantage that the display device is less prone to failure but also that undesired vibrating or shaking movements of the projection unit—as conventionally occurring particularly upon switch-on of the electric engine—are avoided. Further still, the mechanical connection means advantageously eliminates the need to install strong electric motors for effecting a vertical displacement of the display board. Thus, the connection means provided by the invention is more economical and also more reliable and will thus need less maintenance. Further, display boards can be retrofitted to obtain the display device of the invention.

The connection means can be provided as a linkage arranged e.g. between the display board and the projection unit and connected e.g. to the wall and/or the ceiling of a lecture hall. By the provision of at least one guide element, it can be safeguarded that a vertical displacement of the display board will also cause a vertical displacement of the projection unit into the same direction.

According to a particularly preferred embodiment of the invention, the connection means comprises a guide element, particularly a guide pulley and a connection element, which particularly is a flexible connection element such as e.g. a rope or a chain. In this arrangement, the connection element, according to a preferred embodiment of the invention, is guided around the guide element in such a manner that the connection element will undergo a change of direction. This effect can be reliably obtained in that the flexible connection element is passed around the guide element by about 180°. Of course, e.g. for stabilization purposes, the connection element can additionally be wrapped a plurality of times completely around the guide element. The angle of wrap will thus be 360°×+180°.

The guide element, which is particularly provided as a guide pulley, is preferably stationary. For this purpose, the guide pulley is connected e.g. to a wall. In this arrangement, the axis of rotation of the guide element is preferably oriented horizontally.

Further, the display board and/or the projection unit is connected to guide elements, such as e.g. guide rails, for vertical guidance. Particularly in case of the projection unit, this is advantageous for minimizing a swinging or shaking movement caused by the displacement.

The mechanical connection means can be a of a hydraulic and/or pneumatic type. Of particular advantage in this regard is a combination of a mechanical connection means with a hydraulic and/or pneumatic connection means. Particularly, such a combination makes it possible to utilize the hydraulics or pneumatics for supporting the mechanical connection means so that the displacement or adjustment of the height can be performed easily by application of merely little force.

A preferred embodiment of the invention will be explained in greater detail hereunder with reference to the accompanying drawings.

### BRIEF DESCRIPTION OF THE DRAWINGS

FIG. 1 is a schematic lateral view of a preferred embodiment of the invention, and

FIG. 2 is a schematic front view of the embodiment illustrated in FIG. 1.

### DETAILED DESCRIPTION OF A PREFERRED EMBODIMENT OF THE INVENTION

The embodiment of the invention illustrated in the drawings comprises a display board 10. The display board 10 is guided by guides 12 (FIG. 2) and is vertically displaceable in the directions indicated by arrow 14. Display board 10 can be e.g. an information board or a blackboard, and the outer surface 16 of display board 10 can be written on by suitable pens or crayons.

The display device further comprises a projection unit 18 adapted for projecting an image onto outer surface 16 of display board 10.

In the illustrated embodiment, display board 10 is connected to a connection element 20 provided as a rope. Connection element 20 is first guided downward towards a guide element 22 which in the illustrated embodiment is a guide pulley. Rope 20 is passed around guide pulley 22 by about 180° and then is guided upward. Guide pulley 22 is rotatable about a horizontal axis and is attached to a wall 24 in stationary arrangement.

By means of two further guide pulleys 28 attached to a ceiling 26 in stationary arrangement, rope 20, traveling upward, is caused to change its direction by respectively 90°, so that the end of rope 20 will extend downward towards projection unit 18. The end of rope 20 is connected to a receptacle 30 serving to accommodate the projection unit 18.

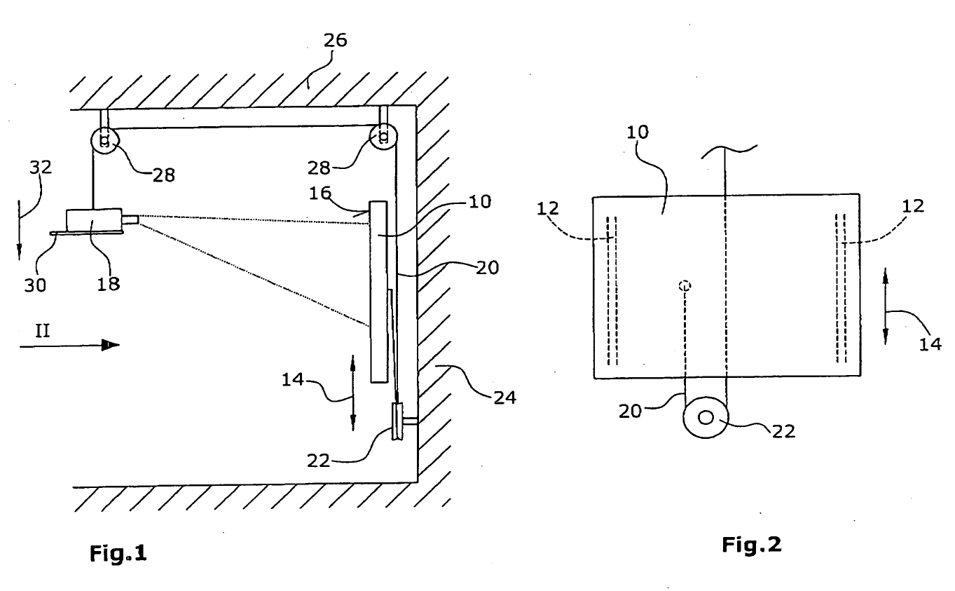

Thus, in the arrangement best illustrated in FIG. 1, a displacement of board 10 in the downward direction has the effect that also the projection unit 18 will be displaced downward in the direction of arrow 32. Due to the rope guidance performed in the above described embodiment, the projection unit 18 will be displaced by the same distance as the display board 10.

1. A display device comprising
a display board (10) adapted to be written on and adjustable in height,
a projection unit (18), adjustable in height, for projecting images onto the display board (10), and
a mechanical connection means (20,22) connecting the display board (10) to the projection unit (18), said connection means (20,22) being configured in such a manner that, upon displacement of the display board (10) or the projection unit (18), a vertical distance between the display board (10) and the projection unit (18) is substantially maintained.

2. The display device according to claim 1, wherein said connection means comprises a guide element (22), particularly a guide pulley, and a connection element (20) particularly of a flexible type.

3. The display device according to claim 2, wherein said connection element (20) is connected to the display board (10) and to the projection unit (18) and is guided around the guide element (22).

4. The display device according to claim 2, wherein said guide element (22) is wrapped by the connection element (20) by substantially 180°.

5. The display device according to claim 2, wherein said guide element (22) is stationary.

6. The display device according to claim 2, wherein said connection element (20) is formed as a rope and/or chain.

7. The display device according to claim 1, wherein the display board (10) and/or the projection unit (18) are connected to guide elements (12) for vertical guidance.
